(19) United States
(12) Patent Application Publication
(10) Pub. No.: US 2012/0314887 A1
(43) Pub. Date: Dec. 13, 2012

(54) VIBRATION UNIT OF SPEAKER

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/272,226

(22) Filed: Oct. 13, 2011

(30) Foreign Application Priority Data
Jun. 9, 2011 (CN) 201110153872.8

(51) Int. Cl. H04R 1/00

(52) U.S. Cl. 381/162

(57) ABSTRACT

An exemplary vibration unit of a speaker includes a diaphragm and a coil connected to the diaphragm. The coil includes a main body, and a lead-out wire extending from a periphery of the main body. The lead-out wire includes a first segment extending from the periphery of the main body and being tangential to the main body, and a second segment extending from the first segment. The first and second segments are adhered to the diaphragm.

### BACKGROUND

1. Technical Field

The present disclosure relates to speakers, and particularly to a vibration unit used in a speaker.

2. Description of Related Art

Generally, a vibration unit of a speaker includes a diaphragm and a coil connected to the diaphragm. The diaphragm vibrates to produce sound following vibration of the coil. For a small sized speaker, a lead-out wire of the coil is adhered on a central part of the diaphragm directly, and vibrates frequently along with the vibration of the diaphragm. Therefore the lead-out wire is prone to break away from and fall off the diaphragm, whereupon the performance of the vibration unit may be unstable.

What is needed, therefore, is a vibration unit which can overcome the described limitations.

### BRIEF DESCRIPTION OF THE DRAWINGS

FIG. 1 is a top view of a vibration unit of a speaker according to an embodiment of the present disclosure.

FIG. 2 is a cross sectional view of a diaphragm of the vibration unit of the speaker of FIG. 1, taken along line II-II thereof.

### DETAILED DESCRIPTION

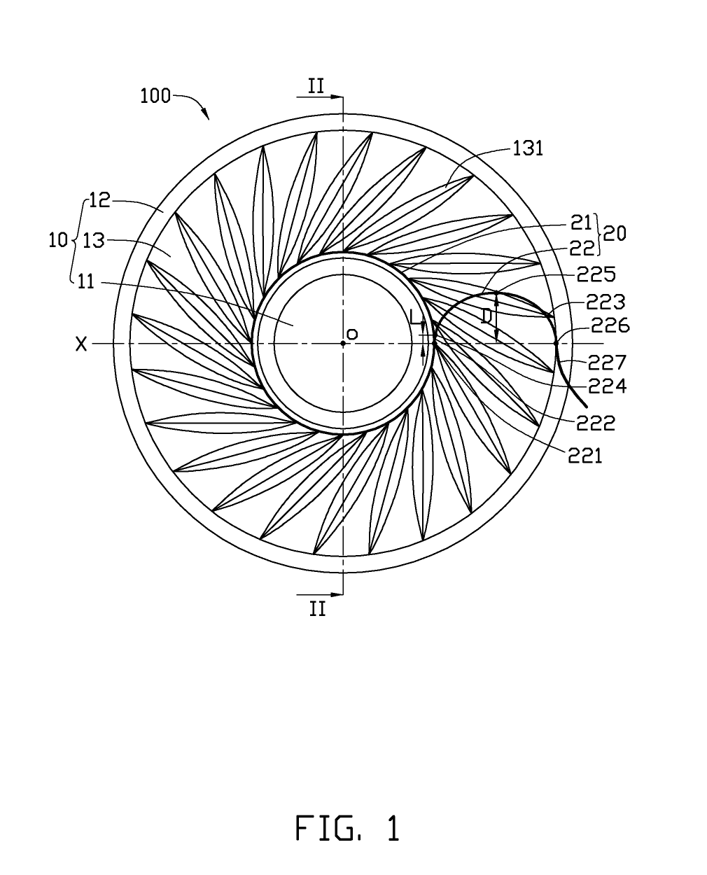

Referring to FIG. 1, a vibration unit 100 of a speaker is shown. The vibration unit 100 includes a diaphragm 10, and a coil 20 connected to the diaphragm 10.

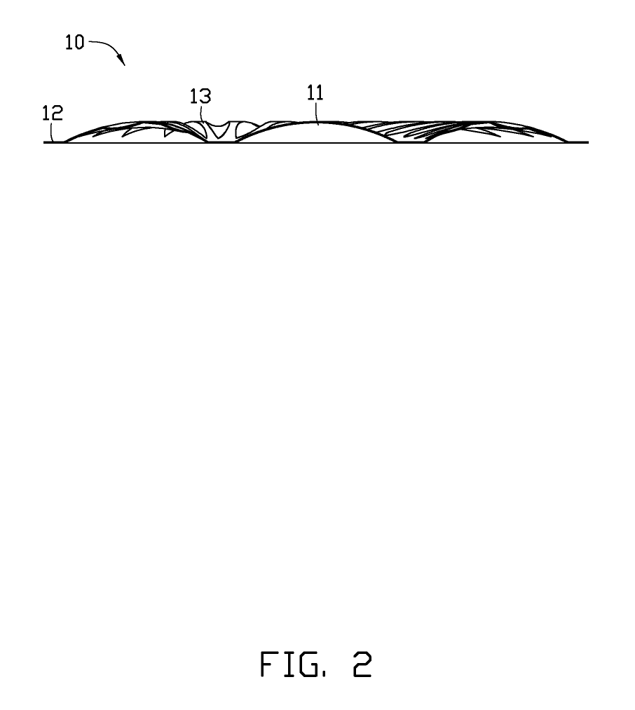

Referring also to FIG. 2, the diaphragm 10 is circular in profile. The diaphragm 10 includes a dome-like central portion 11, an annular pleat portion 13, and an annular flange 12. The central portion 11 has a central point O. The pleat portion 13 extends outwardly from an outer periphery of the central portion 11, and an inner part of the pleat portion 13 has a shape similar to the sound output end of a bugle. In particular, the inner part of the pleat portion 13 has a generally flared, frustoconical-like configuration. A diameter of the pleat portion 13 generally increases from an inner periphery thereof connected to the central portion 11 to an outer periphery thereof away from the central portion 11 (i.e., where the outer periphery of the pleat portion 13 is connected to the flange 12).

A plurality of pleats 131 is defined in a top surface of the pleat portion 13.

Each pleat 131 is curved, and extends from the outer periphery of the central portion 11 at an oblique angle, towards the flange 12. In particular, each pleat 131 is curved (e.g., double-arc-shaped) when viewed from above (see FIG. 1), and also has a curved profile when viewed from an inner end of the pleat 131 (see FIG. 2). Each pleat 131 faces another corresponding pleat 131 across a pleat channel (not labeled) therebetween. Thus the pleats 131 are arranged in pairs. In each pair of pleats 131, each of the pleats 131 is oriented to be concave with respect to the other pleat 131. In each pair of pleats 131, inner ends of the pleats 131 at the outer periphery of the central portion 11 connect with each other where they connect with the outer periphery of the central portion 11, and opposite outer ends of the pleats 131 at the flange 12 connect with each other where they connect with the flange 12. A bottom extremity of each of the pleats 131 is curved (e.g., arc-shaped, bulging upward) when the pleat 131 is viewed from a lateral side thereof (see FIG. 2), and the bottom extremity of each pleat 131 is straight when the pleat 131 is viewed from above (see FIG. 1). In each pair of pleats 131, the bottom extremities of the pleats 131 connect with each other along the entire lengths of the bottom extremities. With such configuration, each pleat channel has an elongated configuration when viewed from above (see FIG. 1), with the pleat channel gradually tapering from a middle thereof to each of the inner end and an outer end thereof. In particular, the inner end of the pleat channel is pointed (pointy), and the outer end of the pleat channel is also pointed (pointy).

The pairs of pleats 131 are arranged uniformly around the central portion 11, such that the outer ends of the pleats 131 all point in a generally clockwise direction. Alternatively, the pleats 131 can be uniformly arranged around the central portion 11, such that the outer ends of the pleats 131 all point in a generally counterclockwise direction. The central portion 11, the pleat portion 13 and the flange 12 are all coaxial with respect to an imaginary central axis of the diaphragm 10 passing through the central point O.

The coil 20 includes an annular main body 21, and a lead-out wire 22 extending outwardly from the main body 21. The main body 21 is attached to a joint of the central portion 11 and the pleat portion 13 of the diaphragm 10. The lead-out wire 22 includes a first adhering point 221. The first adhering point 221 is at a joint of the lead-out wire 22 and the main body 21, and is adhered to the diaphragm 10. The lead-out wire 22 includes a first segment 222 extending from the first adhering point 221, and a second segment 223 extending from an end of the first segment 222 far away from the first adhering point 221. The first segment 222 is tangential to the main body 21. A length L of the first segment 222 is not less than 1 millimeter.

The second segment 223 is arc-shaped and includes at least a second adhering point 224, a third adhering point 225 and a fourth adhering point 226. The second adhering point 224 is at a joint of the first segment 222 and the second segment 223. The third adhering point 225 is located at a middle of the second segment 223. The fourth adhering point 226 is at an outer terminal of the second segment 223. The first adhering point 221, the second adhering point 224, the third adhering point 225 and the fourth adhering point 226 are adhered to the diaphragm 10 to mount the lead-out wire 22 on the diaphragm 10. In this embodiment, the fourth adhering point 226 is located at a joint of the pleat portion 13 and the flange 12. The second segment 223 extends along a direction similar to that of an adjacent one of the pleats 131. A shortest distance D between the third adhering point 225 and a straight line X (that runs through the central point O and between the first adhering point 221 and the fourth adhering point 226) is not less than a quarter of a distance between the first adhering point 221 and the fourth adhering point 226. That is, the first adhering point 221, the fourth adhering point 226 and the central point O of the central portion 11 are aligned with each other and positioned on the straight line X (see FIG. 1). The lead-out wire 22 further includes a third segment 227 extending outward from the fourth adhering point 226. A portion of the third segment 227 overlapping the flange 12 is adhered to the flange 12.

In this embodiment, because the first segment 222 of the lead-out wire 22 is tangential to the main body 21 of the coil 20, a vibration force focused on the first adhering point 221 is reduced. Therefore, the lead-out wire 22 avoids becoming fatigued or damaged at the first segment 222. In addition, because the second segment 223 has the arc-shaped configuration, a vibration force focused on each of the second adhering point 224, the third adhering point 225 and the fourth adhering point 226 is reduced. This helps the lead-out wire 22 avoid becoming fatigued or damaged, and thus helps the lead-out wire 22 avoid breaking away from and falling off the diaphragm 10.

It is to be understood, however, that even though numerous characteristics and advantages of the embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A vibration unit of a speaker, the vibration unit comprising:
a diaphragm; and
a coil connected to the diaphragm, the coil comprising:
a main body; and
a lead-out wire extending from a periphery of the main body, the lead-out wire comprising a first segment, a second segment, and a third segment in sequence, a first adhering point, a second adhering point, a third adhering point and a fourth adhering point being defined in sequence along the lead-out wire, the lead-out wire adhered to the diaphragm at the first, second, third and fourth adhering points for securing the first, second and third segments to the diaphragm;
wherein the first adhering point is at a joint of the first segment of the lead-out wire and the main body, the first segment is tangential to the main body of the coil and is located between the first and second adhering points, the second segment is located between the second and fourth adhering points, the third segment extends outwardly from the fourth adhering point, and the third adhering point is located at a middle of the second segment.

2. The vibration unit of claim 1, wherein the second segment is arc-shaped.

3. The vibration unit of claim 1, wherein a length of the first segment is not less than 1 millimeter.

4. The vibration unit of claim 1, wherein a shortest distance between the third adhering point and a straight line defined by the first adhering point and the fourth adhering point is not less than a quarter of a distance between the first adhering point and the fourth adhering point.

5. The vibration unit of claim 1, wherein the diaphragm has a central point O, and the first adhering point, the fourth adhering point and the central point O are all aligned with each other.

6. The vibration unit of claim 1, wherein the diaphragm comprises a central portion, a pleat portion extending outwardly from an outer periphery of the central portion, and a flange connected to an outer periphery of the pleat portion, and the coil is attached to a joint of the central portion and the pleat portion.

7. The vibration unit of claim 6, wherein the central portion has a dome-like configuration, the pleat portion and the flange are annular, and the central portion, the pleat portion and the flange are coaxial.

8. The vibration unit of claim 7, wherein a diameter of the pleat portion generally increases from an inner periphery thereof connected to the central portion to an outer periphery thereof away from the central portion.

9. The vibration unit of claim 6, wherein a plurality of pleats is defined in a top surface of the pleat portion, and the pleats are arranged uniformly around the central portion.

10. The vibration unit of claim 6, wherein the fourth adhering point is at a joint of the pleat portion and the flange, and the third segment is adhered to the flange.

11. A vibration unit of a speaker, the vibration unit comprising:
a diaphragm; and
a coil connected to the diaphragm, the coil comprising:
a main body; and
a lead-out wire extending from a periphery of the main body, the lead-out wire comprising:
a first segment extending from the periphery of the main body and being tangential to the main body; and
a second segment extending from an end of the first segment distal from the main body;
wherein the first and second segments are adhered to the diaphragm.

12. The vibration unit of claim 11, wherein the second segment is arc-shaped.

13. The vibration unit of claim 11, wherein a length of the first segment is not less than 1 millimeter.

14. The vibration unit of claim 11, wherein the lead-out wire comprises a first adhering point formed at a joint of the lead-out wire and the main body, a second adhering point located at a joint of the first segment and the second segment, a third adhering point located at a middle of the second segment, and a fourth adhering point formed as a terminal of the second segment.

15. The vibration unit of claim 14, wherein a shortest distance between the third adhering point and a straight line defined by the first adhering point and the fourth adhering point is not less than a quarter of a distance between the first adhering point and the fourth adhering point.

16. The vibration unit of claim 14, wherein the diaphragm has a central point O, the first adhering point, the fourth adhering point and the central point O are aligned with each other.

17. The vibration unit of claim 11, wherein the diaphragm comprises a central portion, a pleat portion extending outwardly from an outer periphery of the central portion and a flange connected an outer periphery of the pleat portion, and the coil is attached to a joint of the central portion and the pleat portion.

18. A vibration unit of a speaker, the vibration unit comprising:
a diaphragm; and
a coil comprising:
a main body connected to the diaphragm to drive vibration of the diaphragm; and
a lead-out wire extending from a periphery of the main body, the lead-out wire defining a first adhering point connected to a first location of the diaphragm, and a second adhering point connected to a second location of the diaphragm, the lead-out wire comprising a first segment between the first adhering point and the second adhering point, and the first segment being tangential to the main body.

19. The vibration unit of claim 18, wherein the lead-out wire further comprises an arc-shaped second segment extending from the first segment, and the second segment is adhered to the diaphragm.

20. The vibration unit of claim 18, wherein a length of the first segment is not less than 1 millimeter.
